(19) United States
(12) Patent Application Publication
(10) Pub. No.: US 2025/0289966 A1
(43) Pub. Date: Sep. 18, 2025

(54) AQUEOUS COATING COMPOSITIONS INCLUDING SOLVENT SYSTEMS FOR LOW TEMPERATURE STORAGE AND APPLICATION

(71) Applicant: SWIMC LLC, Cleveland, OH (US)

(72) Inventor: Cory G. MILLER, Cleveland, OH (US)

(21) Appl. No.: 18/861,239

(22) PCT Filed: May 3, 2023
(86) PCT No.: PCT/US2023/066531

§ 371 Date: Oct. 29, 2024

Related U.S. Application Data
(60) Provisional application No. 63/337,789, filed on May 3, 2022.

(51) Int. Cl. C09D 7/65; C09D 7/63; C09D 121/02; C09D 175/04

(52) U.S. Cl. CPC C09D 7/65; C09D 7/63; C09D 121/02; C09D 175/04

(57) ABSTRACT

An aqueous coating composition that includes a monoalcohol and a diol or polyol, and a compound with urea functionality is disclosed. The aqueous coating composition has less than 250 grams per liter VOC, is capable of being quality application to a variety of substrates at temperatures below freezing (32° F.), being stored for more than 2 weeks below freezing without bulk freezing, and being applied by a variety of usual application techniques (brush, roller, sprayer) at temperatures below freezing. The additives may be added individual during manufacturing of the coating composition or added together to a coating composition as a low temperature additive package.

### REFERENCE TO EARLIER FILED APPLICATIONS

Priority is claimed to U.S. Provisional Patent Application No. 63/337,789, filed on May 3, 2022, the entirety of which is incorporated by reference.

### BACKGROUND

Water-based coating compositions balance many competing considerations relating to coating application, drying time, and final appearance. For example, it may be desired for an aqueous coating composition to provide relatively good flowability to facilitate coating application and smooth surface finish while also providing good sag resistance and thick film build to reduce runs and the required number of coating applications. Such characteristics are especially important at low temperatures as conventional waterborne systems become unstable as temperatures near and go below freezing.

Conventional aqueous coating compositions for architectural applications, such as latex-based paints and stains, may be applied in a wide range of conditions. Historically, conditions in which aqueous paints may be applied has been limited to just above freezing (e.g., about 35° F.), because the properties of water-based paints have been adversely impacted close to the freezing point of water.

The use of water-based paint at low temperatures is limited by freezing of wet-state (in-can) coating compositions when exposed to low temperatures for an extended period, as well as changes in rheology of the coating composition at low temperatures, which can manifest as defects in workability, wet edge, and flow and levelling in the wet-state. Application of coating compositions by spraying rather than brush or roller application can manifest additional challenges, such as gun spits, spray tip clogging, atomization, and coverage issues. Moreover, at low temperatures, applied coating compositions may not form an acceptable film, appearing instead to have one or more appearance defects such as a cracked appearance, an excessively gritty appearance, an “orange peel” appearance when the coating fractures, or a “frosted” appearance when the coating freezes prior to drying.

Conventional solutions for providing coatings that may be applied below the freezing point of water include inclusion of a solvent system to regulate water evaporation rate at cold temperatures. Many industries use solvent blends containing ethylene glycol to change the boiling point/freezing point of a liquid. Such approaches, however, provide limited performance benefits in the context of coatings as the volatility of the solvent blend must be carefully balanced to allow for coating coalescence to occur in an appropriate duration.

Conventional inclusion of a solvent blend may be disfavored for other reasons. A solvent blend may contribute unfavorably to volatile organic compound (“VOC”) content. The amount of VOCs that may be present in an exterior coating, moreover, is limited by EPA, state, and local regulations. Such regulations limit the amount of VOCs that may be present to 250, or 100, or 50 g/Liter. In addition, some VOCs are carcinogenic, requiring additional personal protective equipment for use. Inclusion of a solvent system also may not be compatible with spray application of the coating, as coating compositions with higher VOC content may become overly viscous at low temperatures and may partially evaporate after spraying but prior to full adhesion of the coating to the substrate.

Existing commercially-available low temperature aqueous exterior architectural coatings are inadequate. The sole such known product contains at least 150 g/L VOC and thus cannot be distributed to or used in all areas of the United States. In addition, although this product is advertised as being suitable for application at temperatures below freezing, the product manufacturer instructs that it be stored at approximately room temperature (60° F.).

Thus, there is a need for a low VOC aqueous paint composition that can be applied below the freezing point of water by a variety of applicators and to a variety of substrates without visible defects and while maintaining the durability of existing coating compositions.

### SUMMARY OF THE INVENTION

According to one aspect, a low temperature aqueous coating composition is disclosed, the coating composition comprising an aqueous carrier liquid, a polymeric binder, and a diol or polyol having a first ordinary vapor pressure of less than 0.2 mm Hg, and a monoalcohol having a second ordinary vapor pressure, wherein the first ordinary vapor pressure is less than the second ordinary vapor pressure, and a compound having urea functionality, wherein the aqueous coating composition has less than 250 g/L VOCs.

In another aspect, disclosed is an additive package for addition to a coating composition to impart low temperature stability and application capability, the additive comprising a diol or polyol having a first ordinary vapor pressure of less than 0.2 mm Hg, and a monoalcohol having a second ordinary vapor pressure, wherein the first ordinary vapor pressure is less than the second ordinary vapor pressure, and a compound having urea functionality. Also disclosed is a method of making a low temperature coating composition comprising adding the additive package to a polymeric binder.

According to yet another aspect, disclosed is a method of making a low temperature aqueous coating composition comprising adding to a coating composition a diol or polyol having a first ordinary vapor pressure of less than 0.2 mm Hg, and a monoalcohol having a second ordinary vapor pressure, wherein the first ordinary vapor pressure is less than the second ordinary vapor pressure, and a compound having urea functionality.

Aqueous coating compositions of the present invention have less than 250 grams per liter VOC, and are capable of being quality application to a variety of substrates at temperatures below freezing (32° F.), being stored for more than 2 weeks below freezing without bulk freezing, and being applied by a variety of usual application techniques (brush, roller, sprayer) at temperatures below freezing.

The above summary of the invention is not intended to describe each and every embodiment or feature of the invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an image of a frosting appearance on an applied film.

FIGS. 2A, 2B, 2C, and 2D show images of microscopic examination at 100× of a 5 mil drawdown (wet) of a coating on an aluminum panel after the coating is allowed to cure in a 25° F. freezer. FIG. 2A is the coating composition of the present invention. FIG. 2B is Polar Coat®, described in Example 1 below. FIG. 2C is a conventional all-acrylic exterior masonry coating. FIG. 2D is a conventional all-acrylic exterior coating.

### DEFINITIONS

A “latex” polymer means a dispersion or emulsion of polymer particles formed in the presence of water and one or more dispersing or emulsifying agents (e.g., a surfactant, alkali-soluble polymer, or mixtures thereof) whose presence is required to form the dispersion or emulsion. The dispersing or emulsifying agent is typically separate from the polymer after polymer formation. In some examples, a reactive dispersing or emulsifying agent may become part of the polymer particles as they are formed.

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, an aqueous coating composition that contains “an” additive means that the aqueous coating composition includes “one or more” additives.

The term “comprises” and variations thereof do not have a limiting meaning where these terms appear in the description and claims.

The term “on” when used in the context of a coating applied on or to a surface or substrate includes both coatings applied directly to the surface or substrate, as well as coatings applied indirectly to the surface or substrate, such as when a interstitial layer such as a primer or treatment is present between the substrate and the coating.

The phrase “low VOC” when used with respect to a liquid coating composition means that the liquid coating composition contains less than about 250 grams volatile organic compounds per liter composition, excluding water and exempt compounds. The term “very low VOC” means a liquid coating composition that contains less than 150 grams volatile organic compounds per liter of composition, excluding water and exempt compounds. The term “extremely low VOC” means a liquid coating composition that contains less than 50 grams volatile organic compounds per liter of composition, excluding water and exempt compounds.

The term “(meth)acrylic acid” includes either or both of acrylic acid and methacrylic acid, and the term “(meth)acrylate” includes either or both of an acrylate and a methacrylate.

The terms “topcoat” or “final topcoat” refer to an aqueous coating composition which when dried or otherwise hardened provides a decorative or protective outermost finish layer on a substrate, for example, a polymeric membrane attached to a building exterior (e.g., a roof). By way of further explanation, such final topcoats include paints, stains or sealers capable of withstanding extended outdoor exposure (e.g., exposure equivalent to one year of vertical south-facing Florida sunlight) without visually objectionable deterioration, but do not include primers that would not withstand extended outdoor exposure if left uncoated with a topcoat.

The term “free of,” “do not contain,” “does not contain,” “does not include any” and similar phrases are used herein, such phrases are not intended to preclude the presence of trace amounts of the pertinent structure or compound which may be present but were not intentionally used, e.g., due to the presence of environmental contaminants.

### Test Methods

Volatile Organic Compounds (“VOC”s) are defined by regulation of the United States Environmental Protection Agency to be: any compound of carbon, excluding carbon monoxide, carbon dioxide, carbonic acid, metallic carbides or carbonates, and ammonium carbonate, which participates in atmospheric photochemical reactions, other than exempt compounds identified in Title 40 Code of Federal Reulgations, Sec. 51.100. The amount of VOC present in a composition may be measured by gas chromatography via ASTM D6886-18, titled “Standard Test Method for Determination of the Weight Percent of Individual Volatile Organic Compounds in Waterborne Air-Dry Coatings by Gas Chromatography.” VOC amounts are reported in grams/Liter less exempt compounds (g/L).

The “Ordinary Vapor Pressure” of a compound is the compound's vapor pressure at 20° C. and has units of mm Hg. Vapor pressures are available in various chemistry and chemical engineering treatises, including Perry's Chemical Engineering Handbook, Don W. Green and Robert H. Perry, authors; and the CRC Handbook of Chemistry and Physics.

Viscosity measurements are measured via the method in ASTM D562-10 titled “Standard Test Method for Consistency of Paints Measuring Krebs Unit (KU) Viscosity Using a Stormer-Type Viscometer, as modified to allow viscosity measurement when the sample is cooled and equilibrated to a stated temperature.

The bulk freeze stability of a composition may be determined by the Bulk Freeze Test, under which a one gallon container or can of the composition is sealed with a lid and cooled to 25° F. and held for 14 days. The lid is opened and the bulk composition is assessed for freezing. A composition that remains in liquid, flowing form is considered to have passed the test. A composition that has frozen in whole or in part is considered to have failed.

### DETAILED DESCRIPTION

The present disclosure describes low temperature aqueous coating compositions that include an aqueous carrier liquid, a polymeric binder, and a low temperature additive package comprising a diol or polyol having a first ordinary vapor pressure of less than 0.2 mm Hg, a monoalcohol having a second ordinary vapor pressure, and a compound having urea functionality, wherein the first ordinary vapor pressure is less than the second ordinary vapor pressure. The monoalcohol, diol or polyol, and compound having urea functionality may first be mixed then added to a carrier of the coating composition, or may be individually added to the carrier or in combination. The coating composition has less than 250 g/L VOC.

The combination of a diol or polyol, a monoalcohol, and a compound having urea functionality results in a coating composition having more consistent viscosity, application properties, and applied appearance, along with suitable flow and levelling behavior, for spray application at low temperatures. The low temperature additive package of the present invention is compatible with a wide variety of polymeric binders, and exhibits unusually low VOC content when present in a low temperature aqueous coating composition.

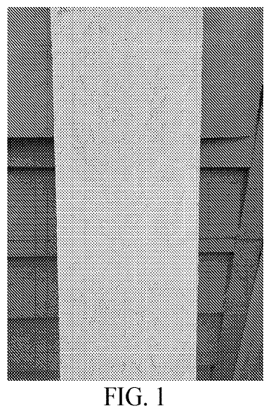

While not wishing to be bound by theory, it is believed that the components of the low temperature additive package of the present invention provide a diol or polyol that decreases decrease the freezing point of the coating composition but results in comparatively lower coalescence of the applied coating; a monoalcohol that provides a sufficiently high vapor pressure to allow an applied film to coalesce prior to freezing; and a urea compound, which is believed to slow freezing of the aqueous coating by interfering with hydrogen bonding that occurs in water of the aqueous carrier. It is additionally believed that the combination of solvents of the current invention slows the evaporation rate of water of the aqueous coating composition, which prevents “frosting,” a patterned appearance of ice crystals manifesting during coalescence of a coating composition applied at lower application temperatures. This patterned “frosting” appearance on an applied film, which is shown in FIG. 1, is irreversible, enduring even after an applied coating composition coalesces and dries.

It has thus been unexpectedly discovered that inclusion in a coating composition of the described monoalcohol, diol or polyol, and urea compound allows for consistent, quality application of the coating composition at low temperatures with unusually low VOC content.

In contrast to existing coating compositions that are marketed as capable of application at temperatures below freezing, embodiments of the present invention are low VOC, and can be stored at temperatures below freezing (32° F.) for several weeks, which allows the composition to be shipped during winter without bulk freezing. The VOC content of coating compositions of the present invention preferably is less than about 250 g/L, less than 150 g/L, less than 100 g/L or most preferably less than 50 g/L. More specifically, coating compositions of the present invention are suitable for storage for more than one month at temperatures below 35° F., preferably below 30° F., below 27° F., below 25° F., or below 23° F. In addition, embodiments of the present invention can be stored at low temperatures and applied by any common application technique, including brushing, sprayed with air or airless sprayer, or roller application. This contrasts with existing formulations, which either bulk freeze or clog when sprayed below freezing.

Coating compositions of the present invention preferably provide consistent, quality application at temperatures below 35° F., preferably below 30° F., below 27° F., below 25° F., or below 23° F.

The monoalcohol of the present invention preferably is a linear or branched C1 to C4 alcohol, and preferably has an ordinary vapor pressure of at least 0.4 mm Hg. Preferably the monoalcohol is 1-butanol or ethanol. Monoalcohols of the present invention are present in a coating composition in an amount from 1.0 to 2.5 weight percent based on the total weight of the aqueous coating composition, or preferably an amount from 1.25 to 2.25 weight percent, or even more preferably, an amount from about 1.5 to about 2.0 weight percent based on the total weight of the aqueous coating composition. Compositions of the present invention may include one or more monoalcohols.

The diol or polyol of the present invention has an ordinary vapor pressure of less than 0.2 mm Hg, and preferably is a C1 to C6 diol. Preferred diols are ethylene glycol, propylene glycol, L-glutamic acid, and/or DL-Serine. Polyols of the present invention may be triol such as glycerol or a simple sugar, preferably a simple sugar selected from the group consisting of mannitol, sorbitol, glucose, sucrose, fructose, or combinations thereof. Diols or polyols of the present invention are present in a coating composition in an amount from 1.0 to 2.5 weight % based on the total weight of the aqueous coating composition, or preferably an amount from 1.25 to 2.25 weight %, or even more preferably, an amount from about 1.5-2.0 weight % based on the total weight of the aqueous coating composition. Compositions of the present invention may include one or more diols or polyols.

Compounds having urea functionality of the present invention have the structure:

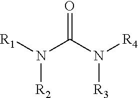

where R1, R2, R3, and R4 are the same or different and comprise a linear or branched alkyl, aromatic, a linear or branched alcohol, or H group. Compounds having urea functionality are preferably urea, 2-hydroxyethyl urea, bis(hydroxymethyl) urea, or combinations thereof. In some approaches, compounds having urea functionality of the present invention are present in a coating composition in an amount of at least 1.75 weight % based on the total weight of the coating composition.

Aqueous coating compositions of the present invention exhibit better flow and rheology compared to other aqueous coating compositions at relatively low temperatures (e.g., about 23° F., about 25° F., about 27° F., about 30° F., or about 35° F.). This rheology, together with the lack of ice crystals from early-stage freezing, facilitates spray atomization, reduces spray gun noise, and eases brush transfer and release compared to other aqueous coating compositions. Coating compositions of the present invention thus have high capability for low temperature application in a wide variety of application techniques (e.g., spray, brush, roller).

Aqueous coating compositions including the low temperature additive package described herein may exhibit better flow and levelling, reduced brush lines, or the like than a coating with less consistent loss tangent after shear, particular aqueous coating compositions that exhibit a lower loss tangent (tan delta) after shear than before shear. Thus, coatings formed from aqueous coating compositions comprising the presently-described solvent system include improved appearance characteristics.

The monoalcohol, diol or polyol, and compound having urea functionality may be added individually to a coating composition during or after manufacturing of the coating composition, or may be added together to a coating composition as an additive package. Components of the low temperature additive system of the present invention may be added individually to a conventional coating composition or may be pre-mixed into a low temperature additive system to be added to a conventional coating composition to improve the coating composition's low temperature effectiveness.

Aqueous coating compositions of the present invention also include a polymeric binder and a carrier. In some examples, the aqueous coating composition may include 20-45 weight percent binder, more preferably 25-40 weight percent binder, and even more preferably 30-35 weight percent based on the total weight of the aqueous coating composition.

The polymeric binder may be any suitable polymeric binder. The polymeric binder may include, for example, a polymeric binder used in a paint formulation, a clear-coat formulation, a stain formulation, a sealant formulation, or the like, and may be used in a water-based formulation or a solvent-free formulation. The polymeric binder may be present in a carrier liquid in some examples and may be dispersed in the carrier liquid (e.g., in an emulsion stabilized colloidally or using a surfactant), present as a solute in the carrier liquid (e.g., in a solution polymer), or the like.

In some examples, the polymer binder may a water-borne polyurethanes, latex, (meth)acrylate, acetate (e.g., ethylene-vinyl acetate), or the like. The polymer binder may be synthetic or may be a naturally occurring polymer, biological polymer, or a bio-based polymer, such as a polysaccharide, a polypeptide, a lipid, a nucleic acid-based polymer, either crosslinked or uncrosslinked. Some example polymer binders include poly(ethylene-vinyl acetate) “PEVA,” a vinyl ester homopolymer or copolymer, a silane or fluorine containing latex emulsion, or the like. For example, the polymeric binder may include a latex-based paint formulation and may include a polymeric binder including a latex copolymer that is surfactant or colloidally stabilized in the latex emulsion.

The latex copolymer may include a (meth)acrylic latex, a vinyl acrylic latex, or a styrene acrylic latex. The latex copolymer may be formed from reactants including methyl acrylate, ethyl acrylate, propyl acrylate, butyl acrylate, 2-ethylhexyl acrylate, methyl methacrylate, ethyl methacrylate, propyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide (DAAM), acrylamide, methacrylamide, methylol (meth)acrylamide, styrene, α-methyl styrene, vinyl toluene, vinyl acetate, vinyl propionate, allyl methacrylate, and mixtures thereof. Some preferred monomers include styrene, methyl methacrylate, methacrylic acid, acetoacetoxy ethyl methacrylate, butyl acrylate, butyl methacrylate, and the like.

In some examples, the reactants that form the latex copolymer also include an ethylenically unsaturated polar component. For example, the ethylenically unsaturated polar component may include an ethylenically unsaturated monomer including at least one alcohol group, an ethylenically unsaturated ionic monomer, an at least partially neutralized ethylenically unsaturated ionic monomer, or the like. The at least partially neutralized ethylenically unsaturated ionic monomer may be a salt form of the ethylenically unsaturated ionic monomer, and the salt form may be formed prior to, during, or after reaction of the ethylenically unsaturated ionic monomer with the other monomers in the reactants to form the latex copolymer.

In some examples, the ethylenically unsaturated polar monomer may include an acid- or anhydride-functional ethylenically unsaturated monomer or an at least partially neutralized acid- or anhydride-functional ethylenically unsaturated monomer. For example, the ethylenically unsaturated polar monomer may include acrylic acid, methacrylic acid, crotonic acid, fumaric acid, maleic acid, 2-methyl maleic acid, itaconic acid, 2-methyl itaconic acid, anhydride variants thereof, at least partially neutralized variants thereof, or combinations thereof.

The carrier of aqueous coating compositions of the present invention is any variety of water, including purified, tap, or distilled water, and may include recycled water.

Aqueous coating compositions of the present invention may also include one or more additives, including coalescents, surfactants, pigments, fillers, extenders, biocides, and UV stabilizers, in amounts and concentrations known to those skilled in the art.

The aqueous coating composition may contain one or more optional coalescents to facilitate film formation. Coalescents suitable for use in the aqueous coating compositions will be known to persons having ordinary skill in the art or can be determined using standard methods. Exemplary coalescents include glycol ethers such those sold under the trade names as EASTMAN™ EP, EASTMAN™ DM, EASTMAN™ DE, EASTMAN™ DP, EASTMAN™ DB and EASTMAN™ PM from Eastman Chemical Company, Kingsport, Tennessee, and ester alcohols such as those sold under the trade names TEXANOL™ ester alcohol from Eastman Chemical Company. The optional coalescent may be a low VOC coalescent such as is described in U.S. Pat. No. 6,762,230 B2. The aqueous coating compositions may include a low VOC coalescent in an amount of at least about 0.5 wt. %, or at least about 1 part by weight, and or at least about 2 wt. %, based on a total non-volatile weight of the latex copolymer. The aqueous coating compositions also may include a low VOC coalescent in an amount of less than about 10 wt. %, or less than about 6 wt. %, or less than about 4 wt. %, based on a total non-volatile weight of the latex copolymer.

The latex copolymers disclosed above may, in some examples, be formed and/or stabilized with one or more emulsifiers (e.g., surfactants), used either alone or together. Examples of suitable nonionic emulsifiers include tert-octylphenoxyethylpoly(39)-ethoxyethanol, dodecyloxypoly(10)ethoxyethanol, nonylphenoxyethyl-poly(40)ethoxyethanol, polyethylene glycol 2000 monooleate, ethoxylated castor oil, fluorinated alkyl esters and alkoxylates, polyoxyethylene (20) sorbitan monolaurate, sucrose monococoate, di(2-butyl) phenoxypoly(20)ethoxyethanol, hydroxyethylcellulosepolybutyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with ethylene oxide, N-polyoxyethylene(20) lauramide, N-lauryl-N-polyoxyethylene(3)amine and poly(10)ethylene glycol dodecyl thioether. Examples of suitable anionic emulsifiers include sodium lauryl sulfate, sodium dodecylbenzenesulfonate, potassium stearate, sodium dioctyl sulfosuccinate, sodium dodecyldiphenyloxide disulfonate, nonylphenoxyethylpoly(1)ethoxyethyl sulfate ammonium salt, sodium styrene sulfonate, sodium dodecyl allyl sulfosuccinate, linseed oil fatty acid, sodium, potassium, or ammonium salts of phosphate esters of ethoxylated nonylphenol or tridecyl alcohol, sodium octoxynol-3-sulfonate, sodium cocoyl sarcocinate, sodium 1-alkoxy-2-hydroxypropyl sulfonate, sodium alpha-olefin (C₁₄-C₁₆)sulfonate, sulfates of hydroxyalkanols, tetrasodium N-(1,2-dicarboxy ethyl)-N-octadecylsulfosuccinamate, disodium N-octadecylsulfosuccinamate, disodium alkylamido poly-ethoxy sulfosuccinate, disodium ethoxylated nonylphenol half ester of sulfosuccinic acid and the sodium salt of tert-octylphenoxyethoxypoly(39)ethoxyethyl sulfate

Aqueous coating compositions of the present invention may include a rheology package comprising one or more thickeners or rheology modifiers to yield a coating composition with appropriate low, medium, and high shear flow characteristics. Suitable rheology packages are described in U.S. Published Patent Application 2020/0291249. Thickeners may include hydroxyethyl cellulose (HEC), xanthan gum, alginates, guar gum, and other cellulose derivatives. Other rheology agents include waterborne clay; a hydrophobically modified alkali-swellable emulsion (HASE); or an associative thickener such as a hydrophobically enhanced urethane (HEUR), a polyether polyol (PEPO), or a hydrophobically modified ethoxylated aminoplast thickener (HEAT).

Waterborne clays include, for example, a magnesium aluminum phyllosilicate such as attapulgite ((Mg,Al)₂Si₄O₁₀(OH)·4(H₂O)), hectorite (Na_{0.3}(Mg,Li)₃Si₄O₁₀(OH)₂), an organically modified hectorite, a synthetic hectorite, or the like. Examples are available under the trade designations MIN-U-GEL® 400 from Active Minerals International, LLC, Sparks, Maryland; and ATTAGEL® 40 and ATTAGEL® 50 from BASF SE, Ludwigshafen, Germany.

Example HASE rheology agents include those available under the trade designations ACRYSOL™ TT-935 from Dow Chemical Company, Midland, Michigan; POLYPHOBE® TR-116 from Arkema Inc., King of Prussia, Pennsylvania; RHEOTECH™ 3800 from Arkema Inc., King of Prussia, Pennsylvania; POLYPHOBE™ PP 102 from Arkema Inc., King of Prussia, Pennsylvania; RHEOLATE® 1 from Elementis Specialties, Inc., East Windsor, New Jersey; ACRYSOL™ ASE-60 from Dow Chemical Company, Midland, Michigan; ACRYSOL™ TT-615, from Dow Chemical Company, Midland, Michigan; ACRYSOL™ DR-300, from Dow Chemical Company, Midland, Michigan; POLYPHOBE® TR-117 from Arkema Inc., King of Prussia, Pennsylvania; and ACRYSOL™ RM-5 from Dow Chemical Company, Midland, Michigan.

Example associative thickeners include those available under the trade designations ACRYSOL™ RM-2020 NPR from Dow Chemical Company, Midland, Michigan; ACRYSOL™ SCT-275 from Dow Chemical Company, Midland, Michigan; ACRYSOL™ RM-825 from Dow Chemical Company, Midland, Michigan; ACRYSOL™ RM-8W from Dow Chemical Company, Midland, Michigan; ACRYSOL™ RM-12W from Dow Chemical Company, Midland, Michigan; RHEOLATE® 350 from Elementis Specialties, Inc., East Windsor, New Jersey; AQUAFLOW™ NHS-310 from Ashland, Inc., Covington, Kentucky; AQUAFLOW™ NHS-350 from Ashland, Inc., Covington, Kentucky; OPTIFLO® L100 from Byk GmbH, Wesel, Germany; OPTIFLO® H3300 VF from Byk GmbH, Wesel, Germany; and OPTIFLO® H370 from Byk GmbH, Wesel, Germany.

The aqueous coating composition may include a surface-active agent (e.g., surfactant) either as part of the rheology package, as part of the aqueous coating composition, or both. The surface-active agent may modify affect dispersion of the rheology package in the aqueous coating composition, modify the interaction of the coating composition with the substrate or with a prior applied coating, or both. The surface-active agent affects qualities of the aqueous coating composition including how the aqueous coating composition is handled, how it spreads across the surface of the substrate, and how it bonds to the substrate. The surface-active agent can modify the ability of the aqueous coating composition to wet a substrate and also may be referred to as a wetting agent. Surface-active agents may also provide leveling, defoaming, or flow control properties, and the like. If the aqueous coating composition includes a surface-active agent, the surface-active agent is preferably present in an amount of less than 5 wt. %, based on the total weight of the aqueous coating composition. Surface-active agents suitable for use in the coating composition will be known to persons having ordinary skill in the art or can be determined using standard methods. Some suitable surface-active agents include those available under the trade designations STRODEX™ KK-95H, STRODEX™ PLF100, STRODEX™ PKOVOC, STRODEX™ LFK70, STRODEX™ SEK50D and DEXTROL™ OC50 from Dexter Chemical L.L.C., Bronx, New York; HYDROPALAT™ 100, HYDROPALAT™ 140, HYDROPALAT™ 44, HYDROPALAT™ 5040 and HYDROPALAT™ 3204 from Cognis Corporation, Cincinnati, Ohio; LIPOLIN™ A, DISPERS™ 660C, DISPERS™ 715W and DISPERS™ 750W from Degussa Corporation, Parsippany, New Jersey.; BYK™ 156, BYK™ 2001 and ANTI-TERRA™ 207 from Byk Chemie, Wallingford, Connecticut; DISPEX™ A40, DISPEX™ N40, DISPEX™ R50, DISPEX™ G40, DISPEX™ GA40, EFKA™ 1500, EFKA™ 1501, EFKA™ 1502, EFKA™ 1503, EFKA™ 3034, EFKA™ 3522, EFKA™ 3580, EFKA™ 3772, EFKA™ 4500, EFKA™ 4510, EFKA™ 4520, EFKA™ 4530, EFKA™ 4540, EFKA™ 4550, EFKA™ 4560, EFKA™ 4570, EFKA™ 6220, EFKA™ 6225, EFKA™ 6230 and EFKA™ 6525 from Ciba Specialty Chemicals, Tarrytown, New York; SURFYNOL™ CT-111, SURFYNOL™ CT-121, SURFYNOL™ CT-131, SURFYNOL™ CT-211, SURFYNOL™ CT 231, SURFYNOL™ CT-136, SURFYNOL™ CT-151, SURFYNOL™ CT-171, SURFYNOL™ CT-234, CARBOWET™ DC-01, SURFYNOL™ 104, SURFYNOL™ PSA-336, SURFYNOL™ 420, SURFYNOL™ 440, ENVIROGEM™ AD-O1 and ENVIROGEM AE01 from Air Products & Chemicals, Inc., Allentown, Pennsylvania.; TAMOL™ 1124, TAMOL 850, TAMOL 681, TAMOL™ 731 and TAMOL™ SG-1 from Rohm and Haas Co., Philadelphia, Pennsylvania; IGEPAL™ CO-210, IGEPAL™ CO-430, IGEPAL™ CO-630, IGEPAL™ CO-730, and IGEPAL™ CO-890 from Rhodia Inc., Cranbury, New Jersey; T-DET™ and T-MULZ™ products from Harcros Chemicals Inc., Kansas City, Kansas; polydimethylsiloxane surface-active agents (such as those available under the trade designations SILWET™ L-760 and SILWET™ L-7622 from OSI Specialties, South Charleston, West Virginia, or BYK™ 306 from Byk-Chemie) and fluorinated surface-active agents (such as that commercially available as FLUORAD™ FC-430 from 3M Co., St. Paul, Minnesota). Preferably, the surfactant is free of alkylphenol ethoxylates (APEOs). Preferably, the coating composition is free of alkylphenol ethoxylates (APEOs)

In some examples, the surface-active agent may be a defoamer. The aqueous coating composition may include a single surface-active agent, or multiple surface-active agents, e.g., a first surface-active agent and a second defoamer. Some suitable defoamers include those sold under the trade names BYK™ 018, BYK™ 019, BYK™ 020, BYK™ 022, BYK™ 025, BYK™ 032, BYK™ 033, BYK™ 034, BYK™ 038, BYK™ 040, BYK™ 051, BYK™ 060, BYK™ 070, BYK™ 077 and BYK™ 500 from Byk Chemie; SURFYNOL™ DF-695, SURFYNOL™ DF-75, SURFYNOL™ DF-62, SURFYNOL™ DF-40 and SURFYNOL™ DF-110D from Air Products & Chemicals, Inc.; DEEFO™ 3010A, DEEFO™ 2020E/50, DEEFO™ 215, DEEFO™ 806-102 and AGITAN™ 31BP from Munzing Chemie GmbH, Heilbronn, Germany; EFKA 2526, EFKA 2527 and EFKA 2550 from Ciba Specialty Chemicals; FOAMAX™ 8050, FOAMAX™ 1488, FOAMAX™ 7447, FOAMAX™ 800, FOAMAX™ 1495 and FOAMAX 810 from Degussa Corp.; FOAMASTER™ 714, FOAMASTER™ A410, FOAMASTER™ 111, FOAMASTER™ 333, FOAMASTER™ 306, FOAMASTER™ SA-3, FOAMASTER™ AP, DEHYDRAN™ 1620, DEHYDRAN™ 1923 and DEHYDRAN™ 671 from Cognis Corp. Suitable defoamers include a mineral oil or a silicone.

The aqueous coating composition may also include one or more pigments, which provide the paint with both decorative and protective features. Pigments are solid particles used to provide the paint with various qualities, including but not limited to color, opacity, and durability. Pigments and other solids may add bulk to the paint and may impact the gloss or flatness of the paint. Some suitable pigments include titanium dioxide white, carbon black, lampblack, black iron oxide, red iron oxide, yellow iron oxide, brown iron oxide (a blend of red and yellow oxide with black), phthalocyanine green, phthalocyanine blue, organic reds (such as naphthol red, quinacridone red and toulidine red), quinacridone magenta, quinacridone violet, DNA orange, or organic yellows (such as Hansa yellow). Pigments may be added alone or as part of a colorant or dye. The aqueous coating composition can also include a gloss control additive or an optical brightener, such as that commercially available under the trade designation UVITEX™ OB from Ciba-Geigy.

In some examples, the aqueous coating composition may include an optional filler or inert ingredient. Fillers or inert ingredients extend, lower the cost of, alter the appearance of, or provide desirable characteristics to the aqueous coating composition before and after curing. Fillers and inert ingredients suitable for use in the aqueous coating composition will be known to persons having ordinary skill in the art or can be determined using standard methods. Some suitable fillers or inert ingredients include, for example, clay, glass beads, calcium carbonate, talc, silicas, feldspar, mica, barytes, ceramic microspheres, calcium metasilicates, organic fillers, and the like.

In certain applications it may also be desirable to include in the aqueous coating composition a biocide that provides wet-state and/or dry-film preservation. Suitable wet-state biocides are known in the art and include isothiazolines such as 2-methyl-4-isothiazolin-3-one (MIT), 5-chloro-2-methyl-4-isothiazolin-3one (CMIT), benz-isothiazolinone (BIT), butylbenz-isothiazolinone (BBIT), and dichlorooctylisothiazolinone (DCOIT), methyl-benzlmidazole-2-yl carbamate, 3-iodo-2-propynyl-butyl carbamate (IPBC), propiconazole, zinc pyrithione, and zinc oxide. Some suitable biocides or fungicides include those sold under the trade names ROZONE™ 2000, BUSAN™ 1292 and BUSAN 1440 from Buckman Laboratories, Memphis, Tennessee; POLYPHASE™ 663 and POLYPHASE™ 678 from Troy Chemical Corp., Florham Park, New Jersey; and KATHON™ LX from Rohm and Haas Co.

The aqueous coating composition may also include other ingredients that modify properties of the aqueous coating composition as it is stored, handled, or applied, and at other or subsequent stages. Waxes, flatting agents, mar and abrasion additives, and other similar performance enhancing additives may be employed as needed in amounts effective to upgrade the performance of the cured coating and the aqueous coating composition. Some suitable wax emulsions to improve coating physical performance include those sold under the trade names MICHEM™ Emulsions 32535, 21030, 61335, 80939M and 7173MOD from Michelman, Inc. Cincinnati, Ohio and CHEMCOR™ 20N35, 43A40, 950C25 and 10N30 from ChemCor of Chester, New York. Desirable performance characteristics of the coating include adhesion, chemical resistance, abrasion resistance, hardness, gloss, reflectivity, appearance, or combinations of these characteristics, and other similar characteristics. For example, the composition may include abrasion resistance promoting adjuvants such as silica or aluminum oxide (e.g., sol gel processed aluminum oxide).

Other optional additives for use in the aqueous coating compositions herein are described in Koleske et al., Paint and Coatings Industry, April, 2003, pages 12-86. Some performance enhancing additives that may optionally be employed include coalescing solvent(s), dispersants, amines, preservatives, biocides, mildewcides, fungicides, glycols, other colorants or dyes, heat stabilizers, leveling agents, anti-cratering agents, curing indicators, plasticizers, fillers, sedimentation inhibitors, UV absorbers, UV stabilizers, optical brighteners, or other additives to modify properties of the aqueous coating composition.

The aqueous coating composition may be used to coat substrates, e.g., as a primer coat, a topcoat, or a combination primer coat and topcoat. For example, the aqueous coating composition may be used to architectural materials, including brick, concrete, stucco, wood, gypsum board, or the like. As other examples, the aqueous coating composition may be used to coat other materials, such as metals or alloys used in automobiles or other machines, polymeric materials, or the like.

The disclosure will now be illustrated with reference to the following non-limiting examples.

### EXAMPLES

The present invention is illustrated by the following examples, which are employed for the purposes of explanation and are not intended to limit the scope of the invention.

### Example 1

An example of the present invention was made by combining the following components according to standard latex paint mixing techniques. The example included the following components. Listed weight percents are based on the total weight of the composition. F

TABLE 1
Components of Example 1

| Component | Weight % |
|---|---|
| Propylene Glycol | 0.58% |
| Ethanol | 0.58% |
| Urea | 2.01% |
| Acrylic Latex | 38.84% |
| Dispersents | 0.67% |
| Biocides | 3.44% |
| Surfactants | 1.15% |
| Defoamers | 0.57% |
| Titanium Dioxide Slurry | 16.78% |
| Rheology Modifiers | 2.40% |
| HEUR Rheology Modifer | 0.38% |
| HEC Thickener | 0.26% |
| Coalescent | 0.67% |
| Attapulgite Clay | 0.34% |
| Water | 26.20% |
| pH Modifier | 0.27% |
| Extender | 4.85% |
| Total | 100.00% |

### Example 2

An example of the present invention was made by combining the following components according to standard latex paint mixing techniques. The example included the following components. Listed weight percents are based on the total weight of the composition.

TABLE 2
Components of Example 2

| Component | Weight % |
|---|---|
| N-butanol | 1.32% |
| Ethylene-glycol | 1.32% |
| Initiator | 0.08% |
| Urea | 2.02% |
| Associative Thickener | 1.49% |
| HEC Thickener | 0.20% |
| Dispersent | 0.09% |
| Surfactants | 1.23% |
| Coalescents | 1.49% |
| UV Stabilizer | 0.17% |
| Biocides | 0.92% |
| Defoamers | 0.57% |
| Acrylic latexes | 33.32% |
| Water | 14.62% |
| Attapulgite Clay | 0.18% |
| pH Modifier | 0.09% |
| Extender | 18.56% |
| Titanium Dioxide slurry | 18.41% |
| Dry film preservative | 3.95% |
| Total | 100.00% |

### Example 3: Rheology

The Stormer (Krebs Unit) viscosity at room temperature (25° C.) and low temperature (25° F.) was measured of the composition of Example 1 as compared to two commercially available exterior acrylic latex paints.

Stormer (Krebs Unit) viscosity was measured via the method in ASTM D562-10 titled “Standard Test Method for Consistency of Paints Measuring Krebs Unit (KU) Viscosity Using a Stormer-Type Viscometer. Measurements were taken when the temperature of the specimen was 25±0.2° C., and also when the temperature of the specimen was first cooled to 25±2° F. (−3.9° C.).

Table 2 shows Krebs Unit viscosity at room temperature (˜70° F.) of (1) Polar Coat®, available commercially from O'Leary Paint, an exterior 100% acrylic latex coating composition advertised as being suitable for application at temperatures down to 20° F.; and (2) A-100® Exterior 100% Acrylic Latex, commercially-available from the Sherwin-Williams Company; and (3) the composition of Example 1.

TABLE 3
Stormer Viscosity (Krebs Units)

| Sample | 25° C. | 25° F. |
|---|---|---|
| A-100 | 103 | Frozen |
| Polar Coat ® | 102 | 139 |
| Composition of Example 1 | 93.4 | 125 |

The data shows that at room temperature, the example of the present disclosure has relatively the same viscosity as a conventional exterior acrylic latex coating composition at room temperature. At 25° F., the example of the present disclosure shows similar rheology to the Polar Coat® composition, whereas the conventional exterior acrylic latex viscosity was too high to measure, as it froze prior to measurement.

### Example 4: VOC Content

VOC levels were determined for Polar Coat® described in Example 3 and the compositions of Example 1 and Example 2 described above. VOCs were determined by ASTM D6886-14, with analysis performed in duplicate using an Agilent GC 7890A gas chromatograph and 7693 Series Auto Sampler/Injector. Reported data is the mean of two tests, with VOC peaks of >50 ppm included. The results are shown in Table 3 below:

TABLE 4
VOC Levels

| Sample | VOC (g/L) |
|---|---|
| Polar Coat ® | 93 |
| Composition of Example 1 | 48.4 |
| Composition of Example 2 | 99 |

### Example 5: Low Temperature Storage Stability

The composition of Example 1 was prepared with comparably reduced amounts of urea replaced with extender particles to assess the impact of inclusion of urea on freeze stability. The compositions were cooled to 25° F. and the time to bulk freezing of the composition measured.

TABLE 5
Time to Freezing

| Formula | Time to Freezing |
|---|---|
| Example 1 (2.0% Urea) | Greater than 6 weeks |
| Example 1 with 1.5% Urea | Less than 24 hours |
| Example 1 with 1.0% Urea | Less than 24 hours |

### Example 5: Heat-Age Stability

The composition of Example 1 was storage in a temperature-controlled environmental chamber at room temperature and at 120° F. Samples were extracted following two weeks, five weeks, and eight weeks of storage and subjected to a battery of tests to assess whether composition properties were maintained.

| | | Room Temperature | | | 120° F. | | |
|---|---|---|---|---|---|---|---|
| | Start | 2 weeks | 5 weeks | 8 weeks | 2 weeks | 5 weeks | 8 weeks |
| Gloss | 15.5 | 12.7 | 15 | 13.7 | 13.5 | 18.3 | 16 |
| Sheen | 24.7 | 24.8 | 34.6 | 31.4 | 22 | 38.5 | 31.7 |
| Contrast | 0.975 | 0.974 | 0.975 | 0.976 | 0.975 | 0.976 | 0.975 |
| Ratio | | | | | | | |
| Skinning | None | None | None | None | None | None | None |
| | observed | observed | observed | observed | observed | observed | observed |
| Settling | None | None | None | None | None | None | None |
| | observed | observed | observed | observed | observed | observed | observed |
| Syneresis | None | None | None | None | None | None | None |
| | observed | observed | observed | observed | observed | observed | observed |
| Stormer | 102.3 | 99.7 | 101.8 | 101 | 97.8 | 99.2 | 98.5 |
| Viscosity | | | | | | | |
| (KU) | | | | | | | |

### Example 6: Surface Quality of Coating Composition Applied to Substrate

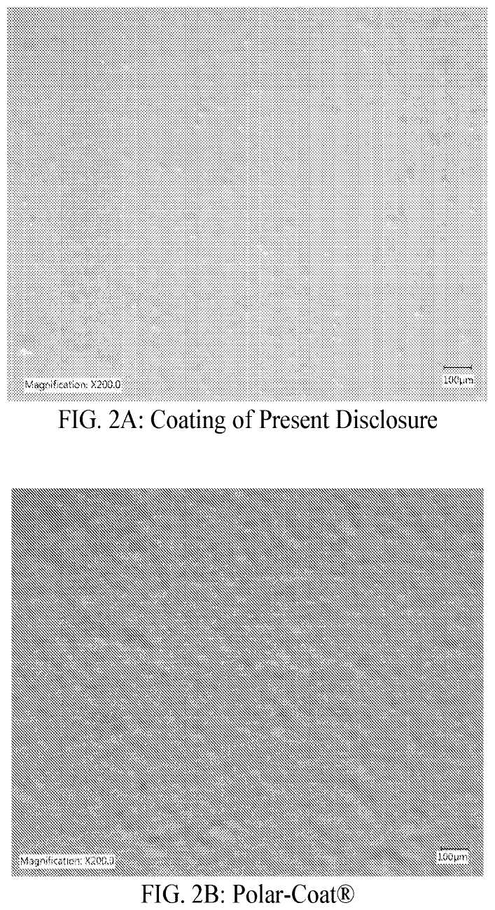

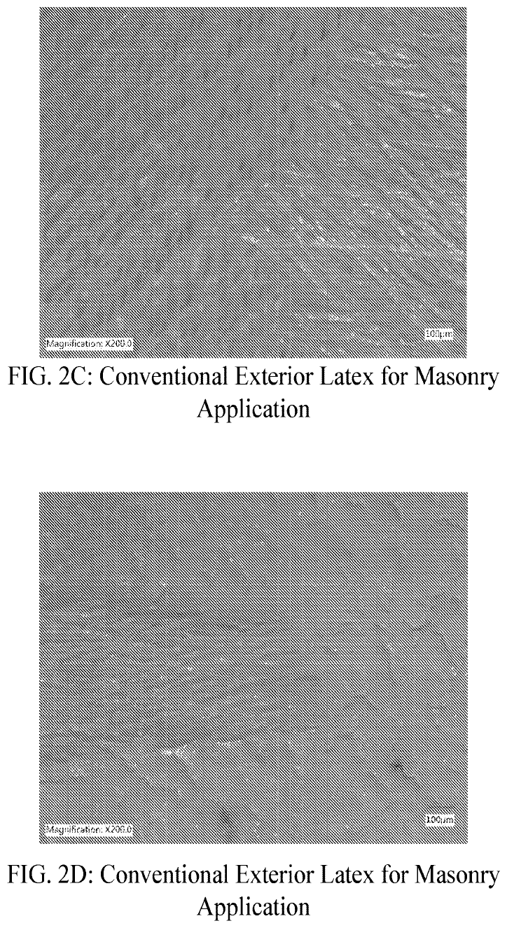

The composition of Example 1, Polar-Coat® described in Example 2, and a conventional 100% acrylic exterior latex were cooled to 25° F., applied at 25° F. via a 5 mil drawdown (wet) to aluminum panels, and allowed to cure in a 25° F. freezer. The cured coatings were then examined on a Keyence optical microscope at 200× magnification using reflectance illumination. Images are shown in FIGS. 2A, 2B, 2C, and 2D.

Conventional all-acrylic latex coating compositions shown in FIGS. 2C and 2D indicate frosting (the appearance of ice crystals on a coated film), whereas the coating of the present disclosure (FIG. 2A) and Polar-coat® (FIG. 2B) do not show frosting or otherwise show cracking of the coating.

### Example 7: Spray Application at Low Temperature Field Test Trial

The low temperature application Example 1 and Polar Coat® described in Example 3 were compared. Polar Coat® was selected as a comparative due to its promotion as being able to be applied at temperatures below freezing. The compositions tested were cooled and allowed to temperature equilibrate at approximately 40° F. The compositions were applied outdoors at an air temperature of approximately 25° F. The compositions were applied to T-111 exterior grade plywood and cementitious Hardieboard® using (a) a Graco GX-19 air-less sprayer with a 0.5 17 tip, (b) by brush, and (c) by roller.

Both Polar Coat® and the composition of Example 3 were applied successfully to the T-111 substrate using each of the three application techniques. When applied to Hardieboard®, both Polar Coat® and the composition of Example 3 showed a “webby” appearance, in which the hiding was uneven. Overall, the composition and Example 3 and Polar Coat® performed relatively equally as to capability of application.

### Example 8: Spray Application at Low Temperature

In a separate application, Polar Coat® and CGM-026 were cooled and equilibration in a temperature controlled chamber to 25° F. Samples were then removed and sprayed using a Graco GX-19 air-less sprayer with a 0.5 17 tip onto cementitious Hardieboard®. The painted substrates were immediately placed in the 25° F. temperature controlled chamber to dry for 1 day.

It was found that Polar Coat® could not be sprayed when at a temperature of 25° F. due to clogging and spitting of the sprayer. CGM-026, however, was able to be sprayed without clogging, spitting, or other indications of application defects.

### Example 9: Outdoor Exposure Testing

Polar Coat® and the composition of Example 3 were applied to the following substrates by brush and in duplicate at a temperature of 25° F. in a temperature controlled environmental chamber and were allowed to cure for one day.
(1) cementitious Hardieboard® primed Loxon® Concrete and Masonry Primer/Sealer, available from The Sherwin-Williams Company;
(2) T-111 exterior grade plywood primed with Exterior Oil-based Wood Primer, available from The Sherwin-Williams Company;
(3) VTW vinyl siding without pretreatment or primer (two coats of Polar Coat® or Example 3 composition applied);
(4) Cedar rough siding primed with Exterior Oil-based Wood Primer, available from The Sherwin-Williams Company;

Following application and curing, the coated substrates were exposed outdoors to weather elements beginning in mid-winter at a location in the midwestern United States, in a state that has cold, snowy winters and hot summers. Exposed to elements beginning in February in a midwestern state that has cold, snowy winters and hot summers.

The samples were graded every three months for general appearance, frosting, cracking, flaking, mildew or algae growth, blistering, dirt pick-up and 60° gloss. The composition of Example 3 showed the same or better characteristics as substrates coated with Polar Coat®.

What is claimed is:

1. A low-temperature aqueous coating composition comprising:
an aqueous carrier liquid;
a polymeric binder;
a diol or polyol having a first ordinary vapor pressure of less than 0.2 mm Hg; and
a monoalcohol having a second ordinary vapor pressure; and
a compound having urea functionality;
wherein the first ordinary vapor pressure is less than the second ordinary vapor pressure; and
wherein the aqueous coating composition has VOC of less than 250 g/L.

2-37. (canceled)

38. The coating composition of claim 1,
wherein the second ordinary vapor pressure is at least 0.4 mm Hg.

39. The coating composition of claim 1,
wherein the monoalcohol is a linear or branched C1 to C4 alcohol.

40. The coating composition of claim 1,
wherein the monoalcohol is ethanol.

41. The coating composition, package, or method of claim 40,
wherein the monoalcohol is 1-butanol.

42. The coating composition, package, or method of claim 1,
wherein the diol or polyol is a diol.

43. The coating composition of claim 42,
wherein the diol is a C1 to C6 diol.

44. The coating composition of claim 43,
wherein the diol is ethylene glycol.

45. The coating composition of claim 43,
wherein the diol is propylene glycol.

46. The coating composition of claim 1,
wherein the diol or polyol is a polyol that is a simple sugar.

47. The coating composition of claim 46,
wherein the simple sugar is selected from the group consisting of mannitol, sorbitol, glucose, sucrose, fructose, and combinations thereof.

48. The coating composition of claim 1,
wherein the diol or polyol is penterythritol.

49. The coating composition of claim 1, wherein the compound having urea functionality comprises urea, and the compound having urea functionality is present in the coating composition in an amount of at least 1.75 wt. % based on the total weight of the aqueous coating composition.

50. The coating composition of claim 1, wherein the diol or polyol is present in an amount of at least about 1.0 wt. % based on the total weight of the aqueous coating composition.

51. The coating composition of claim 1, wherein the monoalcohol is present in an amount of at most about 2.5 wt. % based on the total weight of the aqueous coating composition.

52. The coating composition of claim 1, wherein the monoalcohol is present in an amount of at least 1.0 wt. % based on the total weight of the aqueous coating composition.

53. The coating composition of claim 1,
wherein the coating composition is free of an alkylphenolethoxylate.

54. The coating composition of claim 1,
further comprising a dispersant, a fungicide, an UV stabilizer, a wetting agent, a surfactant, a filler, or a coalescent or combinations thereof.

55. The coating composition of claim 1,
wherein the composition further comprises a pigment.

56. The coating composition of claim 1,
wherein the polymeric binder comprises at least one of a (meth)acrylic latex, a vinyl acrylic latex, a styrene acrylic latex, or a polyurethane.

57. The coating composition of claim 1, wherein the aqueous coating demonstrates a lack of bulk freezing when stored in a freezer at temperatures between 21 and 26 degrees Fahrenheit for 24 hours.

58. An article comprising:
a substrate; and
a coating on the substrate;
wherein the coating includes at least one layer formed from the low-temperature aqueous coating composition of claim 1.

59. A method of making a coated substrate comprising:
applying a coating to a substrate, wherein the coating is formed from the low-temperature aqueous coating composition of claim 1.
